(19) United States
(12) Patent Application Publication
(10) Pub. No.: US 2026/0291056 A1
(43) Pub. Date: Sep. 24, 2026

(54) HEARING AID WITH A DIPOLE ANTENNA

(71) Applicant: Oticon A/S, Smørum (DK)

(72) Inventors: Morten THOUGAARD, Smørum (DK); Jens TROELSEN, Smørum (DK); Rune SØ, Smørum (DK); Oleksandr RYBALKO, Smørum (DK)

(21) Appl. No.: 19/565,583

(22) Filed: Mar. 13, 2026

(30) Foreign Application Priority Data
Mar. 19, 2025 (EP) 25164617.0

(51) Int. Cl. H01Q 1/27; H01Q 9/28; H04R 25/00

(52) U.S. Cl. CPC H01Q 1/273; H01Q 9/285; H04R 25/00

(57) ABSTRACT

Disclosed herein are embodiments of a hearing aid including a dipole antenna. The dipole antenna can be configured for transmitting or receiving a wireless signal. In one or more embodiments, the antenna can be configured to have a current amplitude maximum on a transverse antenna segment. The antenna can include one or more antenna parts.

### CROSS REFERENCE TO RELATED APPLICATIONS

Any and all applications for which a foreign or domestic priority claim is identified in the Application Data Sheet as filed with the present application are hereby incorporated by reference under 37 CFR 1.57.

### TECHNICAL FIELD

The present application relates to the field of hearing aids.

### BACKGROUND

The current distribution on the antenna in a hearing aid is essential for the connectivity performance of the hearing aid. The current distribution significantly influences not only the efficiency, but it also plays a major role for the specific properties of a radio link between a hearing aid worn by a hearing aid user and an external device, e.g. in a pocket of the user.

When designing the antenna for a hearing aid, two attractive properties of the radio link between the hearing aid and the external device in the pocket are minimal changes in antenna efficiency when placed on ears of different people, and the radio link between the hearing aid and the external device being robust for different head gestures.

### SUMMARY

In an aspect of the present application, a hearing aid is provided. The hearing aid may comprise an antenna. The antenna being for transmitting and/or receiving a wireless signal. The antenna may comprise a first antenna part. The first antenna part may comprise a first longitudinal antenna segment. The first longitudinal segment may extend in parallel to a first side of the hearing aid. The first antenna part may comprise a first transverse antenna segment. The first transverse antenna segment may extend from the first longitudinal segment toward a second side of the hearing aid opposite the first side. The antenna may comprise a second antenna part. The antenna may be configured to have a current amplitude maximum on the first transverse antenna segment. The first antenna part and the second antenna part may form a dipole antenna.

By aligning the current amplitude maximum on the transverse antenna segment, it provides for an antenna with a robust coupling to an external device irrespective of head movement. More details on this will be provided in relation FIG. 1 of the present disclosure.

The antenna may be configured to establish a wireless link with an external device. The external device may be a smart phone, a computer, or another hearing aid. The wireless link may be a Bluetooth link where the hearing aid is configured to exchange information with the external device by utilizing the Bluetooth protocol. The antenna may be a resonant antenna.

The first antenna part, if viewed in isolation, may be viewed as a monopole antenna. The first side of the hearing aid may be defined by a housing of the hearing aid, e.g., an outer surface of the housing coinciding with at least part of the first side. The first side of the hearing aid may be understood as a side of the hearing aid arranged farther away from the skull of the user than the second side of the hearing aid while the user is wearing the hearing aid. The first side of the hearing aid may be understood as a side of the hearing aid arranged closer to the auricle of the user than the second side of the hearing aid while the user is wearing the hearing aid. The first side of the hearing aid may extend in parallel to a longitudinal axis of the housing of the hearing aid. The first side of the hearing aid may extend in parallel to a midline of the housing of the hearing aid. The first side of the hearing aid may extend in parallel to a bilateral symmetry plane of the housing of the hearing aid.

The first antenna part may comprise a plurality of antenna segments. The antenna segments of the first antenna part may be straight segments. The segments of the antenna may be bent segments comprising one or more bents. The antenna segments of the first antenna part may join together to form a plethora of different shapes.

The second antenna part, if viewed in isolation, may be viewed as a monopole antenna. The second side of the hearing aid may be defined by a housing of the hearing aid, e.g., an outer surface of the housing coinciding with at least part of the second side. The second side of the hearing aid may be understood as a side of the hearing aid arranged closer to the skull of the user than the first side of the hearing aid while the user is wearing the hearing aid. The second side of the hearing aid may be understood as a side of the hearing aid arranged farther away from the auricle of the user than the first side of the hearing aid while the user is wearing the hearing aid. The second side of the hearing aid may extend in parallel to a longitudinal axis of the housing of the hearing aid. The second side of the hearing aid may extend in parallel to a midline of the housing of the hearing aid. The second side of the hearing aid may extend in parallel to a bilateral symmetry plane of the housing of the hearing aid.

The second antenna part may comprise a plurality of antenna segments. The antenna segments of the second antenna part may be straight segments. The antenna segments of the second antenna part may join together to form a plethora of different shapes.

The first side and the second side may extend in parallel with each other. The first transverse antenna segment extending from the first longitudinal antenna segment toward the second the side of the hearing aid may extend in a plane perpendicular to the first side of the hearing aid and the second side of the hearing aid.

The current amplitude maximum may be understood as a local maximum for the current. For a dipole antenna a current amplitude maximum can normally be found at feeding point(s) of the dipole antenna, and afterwards maximum current amplitudes may be found at increments of half a wavelength of the wavelength at which the antenna is operating, for example for a Bluetooth antenna half a wavelength is around 6 cm in free space, the real distance of the antenna when implemented in a hearing aid may vary due to loading of the antenna. Thus, the first transverse antenna segment or at least the current amplitude maximum associated with the first transverse antenna segment may be understood as an antenna segment or point on the first transverse antenna segment removed at least half a wavelength of an operational wavelength of the antenna away from the feeding point associated with the first antenna part.

Hence, a local current amplitude maximum is not only present at the feeding point, but is also realized on the transverse antenna segment(s). The first transverse antenna segment or at least the point on the first transverse segment associated with the current amplitude maximum may be understood as being removed at least half a wavelength of an operational wavelength of the antenna away from the feeding point associated with the corresponding antenna part. The second transverse antenna segment or at least the point on the second transverse segment associated with the current amplitude maximum may be understood as being removed at least half a wavelength of an operational wavelength of the antenna away from the feeding point associated with the corresponding antenna part. The feeding point may be defined as a point on the antenna part where current is fed to the antenna part, and the half-wavelength spacing is framed in terms of the wavelength at which the antenna is intended to operate. By selecting the conductive path length(s) and segment layout such that a half-wavelength (or greater) separation exists between the feed and the transverse segment, the transverse segment(s) can coincide with one of the expected standing-wave current maxima away from the feed region.

A feeding point may in the present disclosure be understood as a point on the antenna where a current is fed to the antenna.

The first antenna part may have a length of three quarters of a wavelength at which the antenna is intended to operate. The second antenna part may have a length of three quarters of a wavelength at which the antenna is intended to operate. The second antenna part may have a length of one quarter of a wavelength at which the antenna is intended to operate.

The dipole antenna formed by the first antenna part and the second antenna part may comprise an excitation point that serves as a feeding point at which current is fed to the antenna. Each of the first and second antenna parts may be regarded as an “arm” that is fed at one end (i.e., at or adjacent the excitation point) and extends away from the excitation point along its respective sequence of segments. Each of the first and the second antenna part may terminate at a free end opposite the end feeding the antenna part. Each antenna part may comprise a conductive path that runs from the fed end to a termination at the free end.

The hearing aid may comprise transceiver circuitry electrically connected to the antenna to allow the transceiver circuitry to receive electric signals from the antenna, and to send electric signals to the antenna.

The hearing aid may comprise an output unit for providing a stimulus perceived by the user as an acoustic signal based on a processed electric signal. The output unit may comprise an output transducer. The output transducer may comprise a receiver (loudspeaker) for providing the stimulus as an acoustic signal to the user (e.g. in an acoustic (air conduction based) hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation).

The hearing aid may comprise an input unit for providing an electric input signal representing sound. The input unit may comprise an input transducer, e.g., a microphone, for converting an input sound to an electric input signal. The input unit may comprise a wireless receiver for receiving a wireless signal comprising or representing sound and for providing an electric input signal representing said sound.

The wireless receiver and/or transmitter may be configured to receive and/or transmit an electromagnetic signal in the radio frequency range (3 kHz to 300 GHz). The wireless receiver and/or transmitter may be configured to receive and/or transmit an electromagnetic signal in a frequency range of light (e.g., infrared light 300 GHz to 430 THz, or visible light, e.g., 430 THz to 770 THz).

The hearing aid may comprise antenna and transceiver circuitry allowing a wireless link to an entertainment device (e.g., a TV-set), a communication device (e.g., a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g., an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may comprise a hearing instrument, e.g. a hearing instrument adapted for being located at the ear or fully or partially in the ear canal of a user.

In an embodiment the first antenna part comprises a second longitudinal antenna segment extending in parallel to the second side of the hearing aid, where the second longitudinal antenna segment is arranged closer to the second side of the hearing aid than the first longitudinal antenna segment.

The antenna according to the present disclosure may be a bilateral symmetric antenna, i.e., the antenna may be symmetric around a plane separating the antenna into two portions.

In an embodiment the first longitudinal antenna segment, the first transverse antenna segment, and the second longitudinal antenna segment form a hook shape when viewed from a plane perpendicular on the first side and the second side of the hearing aid.

The first longitudinal antenna segment, the first transverse antenna segment, and the second longitudinal antenna segment may form a J-shape when viewed from a plane perpendicular on the first side and the second side of the hearing aid.

In an embodiment the first antenna part and the second antenna part each has a length of three quarters of a wavelength of operation of the antenna.

By having both antenna parts having a length of three quarters of a wavelength of operation of the antenna it allows for a current amplitude maximum away from the feeding point on each of the antenna parts. Thus, both antenna parts of the dipole antenna may have radiating segments which are removed a distance from the feeding point associated with the antenna part, thus, giving a higher degree of freedom in forming the field radiated by the antenna.

In an embodiment the second antenna part comprises a third longitudinal antenna segment extending in parallel to the first side of the hearing aid, and a second transverse antenna segment extending from the third longitudinal antenna segment toward the first side of the hearing aid, where the antenna is configured to have a current amplitude maximum on the second transverse antenna segment, where the third longitudinal antenna segment is arranged closer to the second side of the hearing aid than the first longitudinal antenna segment.

Thus, the first transverse antenna segment and the second antenna segment may synergize with each other by both emitting a radio field directed in the same direction.

In an embodiment the second antenna part comprises a fourth longitudinal antenna segment extending in parallel to the second side of the hearing aid, where the fourth longitudinal antenna segment is arranged closer to the first side of the hearing aid than the third longitudinal antenna segment.

In an embodiment the second transverse antenna segment, and the fourth longitudinal antenna segment form a hook shape when viewed from a plane perpendicular on the first side and the second side of the hearing aid.

In embodiments both the first antenna part and the second antenna part each form a hook shape, where the respective hook shapes may be nested within each other.

In an embodiment the second transverse antenna segment is arranged extending in parallel and proximate the first transverse antenna segment.

In the present disclosure the term proximate may be interpreted to mean the distance between the first transverse antenna segment and the second transverse antenna segment could be less than 0.5 mm, less than 1 mm, or less than 2 mm.

In an embodiment the first antenna part has a length of three quarters of a wavelength of operation of the antenna, and the second antenna part has a length of a quarter of the wavelength of operation of the antenna.

In an embodiment the hearing aid is a behind the ear, BTE, hearing aid.

A BTE hearing aid may be understood as a hearing aid where at least part of the hearing aid is configured to be arranged behind the ear of the user wearing the hearing aid, an audio signal may then be delivered to the user via a sound tube or a receiver arranged in the ear and connected to the part of the hearing aid arranged behind the ear of the user.

In an embodiment the hearing aid comprises a hearing aid housing, where the antenna is arranged within the hearing aid housing.

The housing may be configured to be worn behind the ear of a user wearing the hearing aid. The housing may comprise an outer shell. The outer shell may be made from a polymer material. A rack structure may be arranged within the outer shell. The rack structure may be configured to support one or more electrical components arranged within the hearing aid. The rack structure and/or the outer shell may be configured to support the antenna.

In an embodiment the hearing aid comprises a main printed circuit board carrying one or more electrical components and being arranged within the hearing aid housing, where the first transverse antenna segment is arranged in-between the hearing aid housing and the main printed circuit board.

The main printed circuit board may be supported by a rack structure arranged within the housing of the hearing aid.

The main printed circuit board may comprise a first main side and a second main side, where the one or more electrical components are configured to be placed on the first main side and/or the second main of the main printed circuit board. The first transverse antenna segment may be arranged in-between the hearing aid housing and the first main side and/or the second main side of the main printed circuit board.

In an embodiment where the antenna comprises a first and a second transverse antenna segment both antenna segments may be arranged in-between the hearing aid housing and the main printed circuit board

In an embodiment the one or more electrical components comprises one or more microphones.

In an embodiment the first antenna part and the second antenna part are concentric.

In embodiments where the antenna parts are nested within each other the antenna parts may be concentric with each other.

In an embodiment the first antenna part and the second antenna each terminate with a free end.

Thus, the hearing aid is designed with a first antenna part and a second antenna, both of which terminate with a free end. This configuration allows each antenna segment to operate independently, potentially enhancing the effectiveness of wireless communication within the device. The free ends of the antenna segments may be strategically positioned to optimise signal reception and transmission, ensuring reliable connectivity with auxiliary devices such as remote controls, smartphones, or audio gateway devices.

In an embodiment, the free ends of the first antenna part and the second antenna part may be positioned so that they are located opposite the respective feed ends of each antenna part. This arrangement ensures that the antenna parts are fed from one end, while their free ends terminate at a point on the structure opposed to the feed location. Such a configuration can help optimise the electromagnetic characteristics of the antenna within the hearing aid housing and may contribute to efficient signal transmission and reception.

In an aspect, a hearing system comprising a hearing aid as described above, in the ‘detailed description of embodiments’, and in the claims, and an auxiliary device is moreover provided.

The hearing system may be adapted to establish a communication link between the hearing aid and the auxiliary device to provide that information (e.g. control and status signals, possibly audio signals) can be exchanged or forwarded from one to the other.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system.

In the present context, a hearing aid, e.g. a hearing instrument, refers to a device, which is adapted to improve, augment and/or protect the hearing capability of a user by receiving acoustic signals from the user’s surroundings, generating corresponding audio signals, possibly modifying the audio signals and providing the possibly modified audio signals as audible signals to at least one of the user’s ears. Such audible signals may e.g. be provided in the form of acoustic signals radiated into the user’s outer ears and/or acoustic signals transferred as mechanical vibrations to the user’s inner ears through the bone structure of the user’s head and/or through parts of the middle ear.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid or may be an external unit (possibly in combination with a flexible guiding element, e.g. a dome-like element).

A hearing aid may be adapted to a particular user’s needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user’s hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system) and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both user’s ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person’s loss of hearing capability, augmenting or protecting a normal-hearing person’s hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 is a schematic graph of the coupling between a hearing aid antenna and a device in a pocket of a user as a function of the head rotation.

FIG. 2 is a schematic box diagram of a hearing aid according to an embodiment of the present disclosure.

FIGS. 3a and 3b are two schematic drawings of dipole antennas for a hearing aid according to the present disclosure.

FIG. 4 is a schematic drawing of how the antenna of FIG. 3b could be arranged in a housing of a hearing aid.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present disclosure relates to the field of hearing aids.

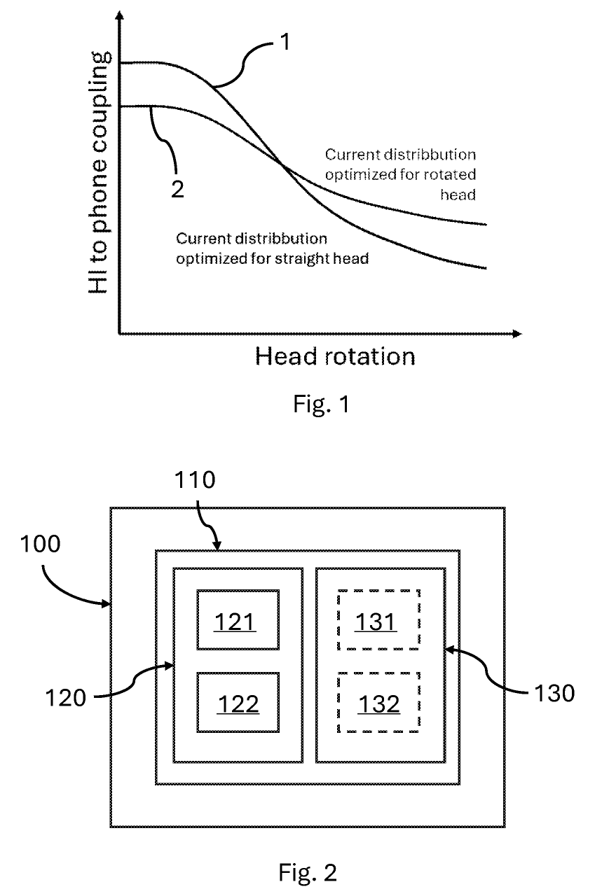

FIG. 1 shows a schematic graph qualitatively depicting the coupling between a hearing aid antenna and a device in a pocket of a user as a function of the head rotation. On the graph two curves 1, 2 are depicted, which qualitatively shows the correlation between coupling between the hearing aid antenna and a pocketed device as a function of head rotation. The first curve 1 depicts the coupling for a hearing aid antenna where the current distribution on the antenna has been designed to optimize coupling when the hearing aid user has not rotated their head. The second curve 2 depicts the coupling for a hearing aid antenna where the current distribution on the antenna has been designed to optimize coupling when the hearing aid user has rotated their head. It must be emphasized that the curves are only of a qualitative nature, however, they are based on general observations made by the applicant. In general, optimizing coupling for a straight head leads to higher variations the coupling as compared to optimizing coupling for a rotated head. Furthermore, optimizing for a straight head leads to a worse worst-case coupling. Thus, to obtain a robust coupling with lower amount of variations it is advantageous to optimize the current distribution of the antenna for a rotated head.

FIG. 2 shows a schematic box diagram of a hearing aid 100 according to an embodiment of the present disclosure. The hearing aid 100 comprises an antenna 110 for transmitting or receiving a wireless signal. The antenna 110 comprises a first antenna part 120. The first antenna part 120 comprises a first longitudinal antenna segment 121 extending in parallel to a first side of the hearing aid 100. The first antenna part 120 comprises a first transverse antenna segment 122 extending from the first longitudinal antenna segment 121 towards a second side of the hearing aid 100 opposite the first side. The antenna 100 comprises a second antenna part 130. The antenna 100 is configured to have a current amplitude maximum on the first transverse antenna segment 122. The first antenna part 120 and the second antenna part 130 form a dipole antenna. The first antenna part may comprise a second longitudinal antenna segment extending in parallel to the second side of the hearing aid. The second longitudinal antenna segment may be arranged closer to the second side of the hearing aid than the first longitudinal antenna segment 121. The first longitudinal antenna segment 121, the first transverse antenna segment 122, and the second longitudinal antenna segment may form a hook shape when viewed from a plane perpendicular on the first side and the second side of the hearing aid 100. The first antenna part 120 and the second antenna part 130 may each have a length of three quarters of a wavelength of operation of the antenna 100. The second antenna part 130 may comprise a third longitudinal antenna segment 131 extending in parallel to the first side of the hearing aid 100. The second antenna part 130 may comprise a second transverse antenna segment 132 extending from the third longitudinal antenna segment 131 toward the first side of the hearing aid 100. The antenna 119 may be configured to have a current amplitude maximum on the second transverse antenna segment 132. The third longitudinal antenna segment 131 may be arranged closer to the second side of the hearing aid 100 than the first longitudinal antenna segment 121. The second antenna part 130 may comprise a fourth longitudinal antenna segment extending in parallel to the second side of the hearing aid 100. The fourth longitudinal antenna segment may be arranged closer to the first side of the hearing aid 100 than the third longitudinal antenna segment 131. The third longitudinal antenna segment 131, the second transverse antenna segment 132, and the fourth longitudinal antenna segment may form a hook shape when viewed from a plane perpendicular on the first side and the second side of the hearing aid 100. The second transverse antenna segment 132 may be arranged extending in parallel and proximate the first transverse antenna segment 122. The first antenna part 120 may have a length of three quarters of a wavelength of operation of the antenna 100, and the second antenna part 130 may have a length of a quarter of the wavelength of operation of the antenna 100. The hearing aid 100 may be a behind the ear, BTE, hearing aid. The hearing aid 100 may comprise a hearing aid housing. The antenna 110 may be arranged within the hearing aid housing. The hearing aid 100 may comprise a main printed circuit board carrying one or more electrical components and being arranged within the hearing aid housing. The first transverse antenna segment 121 may be arranged in-between the hearing aid housing and the main printed circuit board. The one or more electrical components may comprise one or more microphones. The first antenna part 120 and the second antenna part 130 may be concentric.

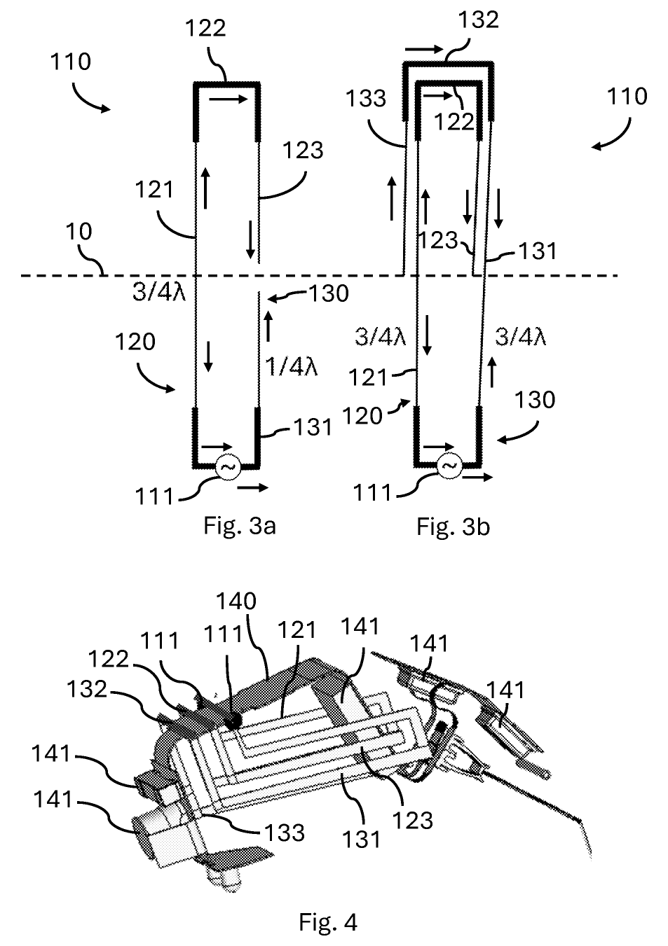

FIGS. 3a and 3b shows two schematic drawings of dipole antennas 110 for a hearing aid 100 according to the present disclosure.

Referring to FIG. 3a which shows an asymmetric dipole antenna 110 according to the present disclosure. The asymmetric dipole antenna 110 comprises an excitation point 111 from which the dipole antenna is fed. The excitation point 111 may also be viewed as a feeding point for the antenna 110. The dipole antenna 110 branches into two parts a first antenna part 120 and a second antenna part 130. The first antenna part 120 has a length of three quarters of a wavelength at which the antenna 110 is intended to operate. The first antenna part 120 comprises a first longitudinal segment 121. The first longitudinal segment 121 is configured to extend in parallel with a first side of the hearing aid 100 opposite a second side of the hearing aid 100. The first antenna part 120 comprises a first traversal segment 122 extending from the first longitudinal segment 121 towards the second side of the hearing aid 100. The first antenna part 120 comprises a second longitudinal segment 123 closer to the second side of the hearing aid 100 than the first longitudinal segment 121. In the shown embodiment the first traversal segment 122 extends from the first longitudinal segment 121 to the second longitudinal segment 123. The segments 121, 122, 123 of the first antenna part 120 form a hook-shape. The second antenna part 130 has a length of a quarter of a wavelength at which the antenna 110 is intended to operate. The second antenna part 130 comprises a third longitudinal segment 131. The third longitudinal segment 131 extends in parallel to the second side of the hearing aid 100 and closer to the second side of the hearing aid 100 than the first longitudinal segment 121.

FIG. 3a illustrates an asymmetric dipole antenna 110 having an excitation (feeding) point 111 at which the antenna is fed, and from which the conductive structure branches into a first antenna part 120 and a second antenna part 130. The first antenna part 120 is formed by a sequence of three segments: a first longitudinal segment 121, a first transverse segment 122, and a second longitudinal segment 123. The first longitudinal segment (121) is arranged to extend generally in parallel with a first side of the hearing aid (opposite a second side), while the transverse segment 122 extends away from the first longitudinal segment 121 toward the second side of the hearing aid. In the depicted configuration, the transverse segment 122 interconnects the first longitudinal segment 121 and the second longitudinal segment 123, the second longitudinal segment 123 being positioned closer to the second side than the first longitudinal segment 121, such that the segments 121, 122, 123 collectively define a “hook” or J-like outline when viewed perpendicular to the first and second sides.

Continuing with FIG. 3a, the second antenna part 130 is geometrically simpler than the first antenna part 120 and is shown as a single elongated segment, namely a third longitudinal segment 131. This third longitudinal segment 131 extends generally in parallel to the second side of the hearing aid and is located closer to the second side than the first longitudinal segment 121 of the first antenna part. In the embodiment described for FIG. 3a, the first antenna part 120 is dimensioned to correspond to approximately three quarters of a wavelength at the intended operating frequency, whereas the second antenna part 130 is dimensioned to correspond to approximately one quarter of a wavelength, thereby yielding the illustrated asymmetry between the two arms as a geometric (length) and layout characteristic.

Referring to FIG. 3b which shows a symmetric dipole antenna 110 according to the present disclosure. The symmetric dipole antenna 110 comprises an excitation point 111 from which the dipole antenna is fed. The excitation point 111 may be viewed as a feeding point for the antenna 110. The dipole antenna 110 branches into two parts a first antenna part 120 and a second antenna part 130. The first antenna part 120 has a length of three quarters of a wavelength at which the antenna 110 is intended to operate. The first antenna part 120 comprises a first longitudinal segment 121. The first longitudinal segment 121 is configured to extend in parallel with a first side of the hearing aid 100 opposite a second side of the hearing aid 100. The first antenna part 120 comprises a first traversal segment 122 extending from the first longitudinal segment 121 towards the second side of the hearing aid 100. The first antenna part comprises a second longitudinal segment 123 closer to the second side of the hearing aid 100 than the first longitudinal segment 121. In the shown embodiment the first traversal segment 122 extends from the first longitudinal segment 121 to the second longitudinal segment 123. The segments 121, 122, 123 of the first antenna part 120 form a hook-shape.The second antenna part 130 has a length of three quarters of a wavelength at which the antenna 110 is intended to operate. The second antenna part 130 comprises a third longitudinal segment 131. The third longitudinal segment 131 extends in parallel to the second side of the hearing aid 100 and closer to the second side of the hearing aid 100 than the first longitudinal segment 121. The second antenna part 130 comprises a second traversal segment 132 extending from the third longitudinal segment 131 towards the first side of the hearing aid 100. The second antenna part 130 comprises a fourth longitudinal segment 133 closer to the first side of the hearing aid 100 than the third longitudinal segment 131. In the embodiment shown the second traversal segment 132 extends from the third longitudinal segment 131 to the fourth longitudinal segment 133. The segments 131, 132, 133 of the second antenna part 130 form a hook-shape.

In the antenna shown on FIG. 3b the first antenna part 120 and the second antenna part 130 are nested within each other.

FIG. 3b likewise shows a dipole antenna 110 with an excitation point 111 from which the structure branches into a first antenna part 120 and a second antenna part 130. The first antenna part 120 in FIG. 3b is again configured as a hook-shaped conductive path defined by the first longitudinal segment 121, the first transverse segment 122, and the second longitudinal segment 123. As described, the first longitudinal segment 121 extends generally parallel to the first side of the hearing aid, the first transverse segment 122 extends from the first longitudinal segment 121 toward the second side, and the second longitudinal segment 123 is positioned closer to the second side than the first longitudinal segment 121, with the transverse segment 122 extending between (and thus joining) the two longitudinal segments 121, 123.

In contrast to FIG. 3a, FIG. 3b depicts the second antenna part 130 as a further hook-shaped path—thus providing geometric symmetry in that each arm has a multi-segment “hook” profile. Specifically, the second antenna part 130 comprises a third longitudinal segment 131, a second transverse segment 132, and a fourth longitudinal segment 133. The third longitudinal segment 131 extends generally parallel to the second side of the hearing aid and is arranged closer to the second side than the first longitudinal segment 121. From the third longitudinal segment 131, the second transverse segment 132 extends toward the first side of the hearing aid and, in the shown embodiment, connects to the fourth longitudinal segment 133, which is positioned closer to the first side than the third longitudinal segment 131. The segments 131, 132, 133 thereby form a second hook-shaped portion. The overall geometry is further characterized in that the first antenna part 120 and the second antenna part 13) are nested within each other, i.e., the two hook shapes are arranged concentrically/overlapping in footprint so that one hook is received within the span of the other. In the described embodiment for FIG. 3b, both the first antenna part 120 and the second antenna part 130 may each have a length of approximately three quarters of a wavelength at the intended operating frequency, reinforcing the symmetrical nature of the two arms as to their conductive path lengths.

On both FIGS. 3a and 3b arrows have are depicted showing the direction of the current on the antenna parts when the phase of the current being fed to the antenna is 0^{o}. Arrows in-between the first antenna part 120 and the second antenna part 130 indicates a direction of the current running in the first antenna part 120. Arrows outside the first antenna part 120 and the second antenna part 130 indicate a direction of the current running in the second antenna part 130. The dotted line 10 indicates a current amplitude minimum. The antenna parts 120, 130 have been bolded to show areas with a larger current amplitude. As can be seen, larger current amplitudes are found near the excitation point 111 and the traversal segments 122, 132. Furthermore, for the symmetric antenna 110 shown on FIG. 3b it can be seen that the direction of the current running in the traversal segments 122, 132 ends up being aligned with each other, thus, leading to a positive interaction between the segments 122, 132 and thereby amplifying the field emitted.

In the above, in relation to FIGS. 3a and 3b a single excitation point 111 is depicted and discussed, however, in some embodiments each antenna part 120, 130 may comprise their respective excitation point 111.

Referring to FIG. 4 showing schematic drawings of how the antenna 110 of FIG. 3b could be arranged in a housing of a hearing aid 100. For the sake of clarity, the outer shell of the housing has been removed. The housing could be a housing for a BTE hearing aid, where the housing is configured to be placed behind the ear of the user. As can be seen arranged within the housing is the antenna 110 and a main printed circuit board 140. The main printed circuit board 140 carries one or more electrical components 141. The one or more electrical components 141 may comprise one or more microphones, transceiver circuitry, a telecoil, or other electrical components. The first transverse antenna segment 122 and the second transverse antenna segment 132 are arranged in-between the hearing aid housing and the main printed circuit board. The longitudinal antenna segments 121, 123, 131, 133 are provided as bent antenna segments, whereas the transverse antenna segments 122, 132 are provided as straight antenna segments. Bending the longitudinal antenna segments 121, 123, 131, 133 can help in facilitating the current amplitude maximums being on the transverse antenna segments 122, 132 by giving a larger freedom in selecting the length of the longitudinal antenna segments 121, 123, 131, 133. Having freedom in selecting the length of the longitudinal antenna segments 121, 123, 131, 133 may facilitate the transverse antenna segments 122, 132 being placed half a wavelength of an intended wavelength of operation of the antenna away from the feeding point of the antenna.

Although FIG. 4 is described with the antenna of FIG. 3b, the antenna of FIG. 3a is equally viable, then instead of the first transverse antenna segment 122 and the second transverse antenna segment 132 the antenna 110 will only have a single transverse antenna segment 122.

It is intended that the structural features of the devices described above, either in the detailed description and/or in the claims, may be combined with steps of the method, when appropriately substituted by a corresponding process.

As used, the singular forms "a," "an," and "the" are intended to include the plural forms as well (i.e. to have the meaning “at least one”), unless expressly stated otherwise. It will be further understood that the terms "includes," "comprises," "including," and/or "comprising," when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being "connected" or "coupled" to another element, it can be directly connected or coupled to the other element, but an intervening element may also be present, unless expressly stated otherwise. Furthermore, "connected" or "coupled" as used herein may include wirelessly connected or coupled. As used herein, the term "and/or" includes any and all combinations of one or more of the associated listed items. The steps of any disclosed method are not limited to the exact order stated herein, unless expressly stated otherwise.

It should be appreciated that reference throughout this specification to "one embodiment" or "an embodiment" or “an aspect” or features included as “may” means that a particular feature, structure, or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

What is claimed is:

1. A hearing aid comprising an antenna for transmitting or receiving a wireless signal, the antenna comprising:
a first antenna part comprising a first longitudinal antenna segment extending in parallel to a first side of the hearing aid, and a first transverse antenna segment extending from the first longitudinal antenna segment towards a second side of the hearing aid opposite the first side,
a second antenna part, and
wherein the antenna is configured to have a local current amplitude maximum on the first transverse antenna segment, wherein the first antenna part and the second antenna part form a dipole antenna, and wherein the local current amplitude maximum on the first transverse antenna segment is removed at least half a wavelength away from a feeding point of the first antenna part.

2. A hearing aid according to claim 1, wherein the first antenna part comprises a second longitudinal antenna segment extending in parallel to the second side of the hearing aid, wherein the second longitudinal antenna segment is arranged closer to the second side of the hearing aid than the first longitudinal antenna segment.

3. A hearing aid according to claim 2, wherein the first longitudinal antenna segment, the first transverse antenna segment, and the second longitudinal antenna segment form a hook shape when viewed from a plane perpendicular on the first side and the second side of the hearing aid.

4. A hearing aid according to claim 1, wherein the first antenna part and the second antenna part each has a length of three quarters of a wavelength of operation of the antenna.

5. A hearing aid according to claim 4, wherein the second antenna part comprises a third longitudinal antenna segment extending in parallel to the first side of the hearing aid, and a second transverse antenna segment extending from the third longitudinal antenna segment toward the first side of the hearing aid, wherein the antenna is configured to have a local current amplitude maximum on the second transverse antenna segment, wherein the third longitudinal antenna segment is arranged closer to the second side of the hearing aid than the first longitudinal antenna segment, and wherein the local current amplitude maximum on the second transverse antenna segment is removed at least half a wavelength away from a feeding point of the second antenna part.

6. A hearing aid according to claim 5, wherein the second antenna part comprises a fourth longitudinal antenna segment extending in parallel to the second side of the hearing aid, wherein the fourth longitudinal antenna segment is arranged closer to the first side of the hearing aid than the third longitudinal antenna segment.

7. A hearing aid according to claim 6, wherein the third longitudinal antenna segment, the second transverse antenna segment, and the fourth longitudinal antenna segment form a hook shape when viewed from a plane perpendicular on the first side and the second side of the hearing aid.

8. A hearing aid according to claim 7, wherein the second transverse antenna segment is arranged extending in parallel with the first transverse antenna segment, and wherein a distance between the first transverse antenna segment and the second transverse antenna segment is less than 2 mm.

9. A hearing aid according to claim 1, wherein the first antenna part has a length of three quarters of a wavelength of operation of the antenna, and the second antenna part has a length of a quarter of the wavelength of operation of the antenna.

10. A hearing aid according to claim 1, wherein the hearing aid is a behind the ear, BTE, hearing aid.

11. A hearing aid according to claim 1, comprising a hearing aid housing, wherein the antenna is arranged within the hearing aid housing.

12. A hearing aid according to claim 11, wherein the hearing aid comprises a main printed circuit board carrying one or more electrical components and being arranged within the hearing aid housing, wherein the first transverse antenna segment is arranged in-between the hearing aid housing and the main printed circuit board.

13. A hearing aid according to claim 12, wherein the one or more electrical components comprises one or more microphones.

14. A hearing aid according to claim 1, wherein the first antenna part and the second antenna part are concentric with each other.

15. A hearing aid according to claim 1, wherein the first antenna part and the second antenna each terminate with a free end.
